(19) United States
(12) Patent Application Publication
(10) Pub. No.: US 2020/0387828 A1
(43) Pub. Date: Dec. 10, 2020

(54) METHOD AND PROCESS FOR USING MACHINE LEARNING TO CATEGORIZE SERVICE SUPPLIERS

(71) Applicant: Premier Healthcare Alliance, LP, Charlotte, NC (US)

(72) Inventors: Mickey Meehan, Walnut Creek, CA (US); Bill Sambrone, Walnut Creek, CA (US); Chris Gormley, Guilford, CT (US)

(73) Assignee: Premier Healthcare Alliance, LP, Charlotte, NC (US)

(21) Appl. No.: 16/894,360

(22) Filed: Jun. 5, 2020

Related U.S. Application Data
(60) Provisional application No. 62/858,817, filed on Jun. 7, 2019.

(51) Int. Cl. G06N 20/00; G06F 16/953; G06F 16/906; G06Q 50/04; G06Q 40/00; G06F 40/295

(52) U.S. Cl. CPC G06N 20/00; G06F 16/953; G06F 40/295; G06Q 50/04; G06Q 40/12; G06F 16/906

(57) ABSTRACT

The present invention relates to a method and process for transforming user files using a machine learning algorithm and a natural language processing to determine and categorize supplier entities. In some embodiments, a method of categorizing suppliers into an identified category includes receiving a resource file from a user, grouping resource line items in the resource file based on supplier entity names, normalizing the supplier's names to match with a device master record and customer's identification, normalizing the supplier entity names to match with a master record and supplier entity identifications, determining if the supplier entities should be categorized in the identified category for any user/particular user in the past, and categorizing the supplier entities in the identified category.

### CROSS-REFERENCE TO PRIORITY APPLICATION

This application claims priority to and the benefit of U.S. Provisional Patent Application Ser. No. 62/858,817, filed Jun. 7, 2019 entitled “Method and Process for using Machine Learning to categorize Service Suppliers,” which is hereby incorporated by reference in its entirety.

### FIELD OF THE DISCLOSURE

The present invention relates to a method and process for transforming user files using a machine learning algorithm and a natural language processing to determine and categorize supplier entities.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention provide a method, system and computer program product for transforming user files using a machine learning algorithm and a natural language processing to determine and categorize supplier entities. In some embodiments, the present invention relates to applying a machine learning algorithm and a natural language processing to user files to categorize supplier entities, such as suppliers, into category types, such as a category of service, based on the supplier entity identifiers, such as supplier names. The computer implemented method, system and computer program product for categorizing supplier entities into an identified category may comprise the following steps: receiving a resource file from a user; grouping resource line items in the resource file based on supplier entity names; normalizing the supplier entity names to match with a master record and supplier entity identifications; determining if the supplier entities should be categorized in the identified category for any user/particular user in the past, and categorizing the supplier entities in the identified category.

In some embodiments, or in combination with any of the previous embodiments, the method further comprises categorizing the supplier entities by a medical device manufacturer.

In some embodiments, or in combination with any of the previous embodiments, the method further comprises categorizing the supplier entities by a medical equipment manufacturer.

In some embodiments, or in combination with any of the previous embodiments, the resource line item is selected from a group consisted of supplier's names, service types provided by the supplier, the amount of money owed to supplier, due date, payment terms, and balance due.

In some embodiments, or in combination with any of the previous embodiments, the master record comprises a spelling of each of the supplier entity names.

In some embodiments, or in combination with any of the previous embodiments, each of the supplier entity's identifications comprises an integer based identifier that uniquely identifies each supplier entity.

In some embodiments, or in combination with any of the previous embodiments, in response to determining that the supplier entity should not be categorized in the identified category, the method further comprises the steps of searching the supplier entity's names across a user database to determine if the supplier entities have been categorized to generate a determined result; and in response to the determined result, using a pre-categorized value to category the supplier entities into an alternative category.

In some embodiments, or in combination with any of the previous embodiments, in response to determining that the supplier entities should not be categorized in the identified category, the method comprises the following steps: submitting the supplier entity's names to a search engine via an application programming interface to generate a searching result; downloading the searching result; applying a natural language processing to pull out relevant keywords from the searching results; and applying a machine learning algorithm to categorize the supplier entities into an alternate category.

In some embodiments, or in combination with any of the previous embodiments, the application programming interface is configured to send requests to the search engine and receive responses therefrom.

In some embodiments, or in combination with any of the previous embodiments, the search engine can connect with a plurality of supplier entity's database through the application programming interface.

In some embodiments, or in combination with any of the previous embodiments, the searching results are in JSON format with all advertisings omitted.

In some embodiments, or in combination with any of the previous embodiments, the relevant keyword is a combination of bigram and trigram word fragments.

According to some aspects of the invention, a method of categorizing suppliers into an identified category comprises receiving an account payable file from a customer; grouping account payable line items in the account payable file by supplier's names; normalizing the supplier's names to match with a master record and supplier's identifications; determining if the suppliers should be categorized in the identified category for any customer/particular customer in the past; and categorizing the suppliers in the identified category.

In another aspect combinable with the general implementation, the method further comprises categorizing the suppliers by a medical device manufacturer.

In another aspect combinable with the general implementation, the method further comprises categorizing the suppliers by a medical equipment manufacturer.

In another aspect combinable with the general implementation, at least one of the account payable line item is selected from a group consisted of supplier's names, service types provided by the supplier, the amount of money owed to suppliers, due date, payment terms, and balance due.

In another aspect combinable with the general implementation, at least one of the master record comprises a spelling of each of the suppliers.

In another aspect combinable with the general implementation, at least one of the each of the supplier's identifications comprises an integer based identifier that uniquely identifies each supplier.

In another aspect combinable with the general implementation, the method further comprises if it is determined that the supplier should not be categorized in the identified category, the method further comprises: searching the supplier's names across a customer database to determine if the suppliers have been categorized to generate a determined result, and in response to the determined result, using a pre-categorized value to category the suppliers into an alternative category.

In another aspect combinable with the general implementation, the method further comprises if it is determined that the suppliers should not be categorized in the identified category, the method further comprises: submitting the supplier's names to a search engine via an application programming interface to generate a searching result; downloading the searching result; applying a natural language processing to pull out relevant keywords from the searching results; applying a machine learning algorithm to categorize the suppliers into an alternate category.

In another aspect combinable with the general implementation, at least one of the application programming interface is configured to send requests to the search engine and receive responses therefrom.

In another aspect combinable with the general implementation, at least one of the search engine can connect with a plurality of supplier's database through the application programming interface.

In another aspect combinable with the general implementation, at least one of the searching results are in JSON format with all advertisings omitted.

In another aspect combinable with the general implementation, at least one of the relevant keyword is a combination of bigram and trigram word fragments.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates a processing system environment in accordance with one embodiment of the invention.

FIG. 2 illustrates a high level process flow for a method and process for transforming user files using a machine learning algorithm and a natural language processing to determine and categorize supplier entities, in accordance with one embodiment of the invention.

FIG. 3 illustrates a high level process flow for a method and process for transforming user files using a machine learning algorithm and a natural language processing to determine and categorize supplier entities, in accordance with one embodiment of the invention.

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In some embodiments, an “entity” or “supplier entity” as used herein may be any institution associated with providing resources. In some embodiments, the “entity” or “supplier entity” is a supplier associated with providing medical resources such as medical devices, medical equipment, and/or the like. That said, the entity or supplier entity may be any institution, group, association, establishment, company, union, manufacturer, supplier, and/or the like. Each supplier entity may be associated with supplier entity identifiers, such as supplier names.

In some embodiments, a “user” as used herein may be any individual or institution associated with receiving resources from the supplier entity, e.g., via a resource transfer therebetween. In some embodiments, the “user” is also referred to as a customer of the supplier entity (e.g., a supplier).

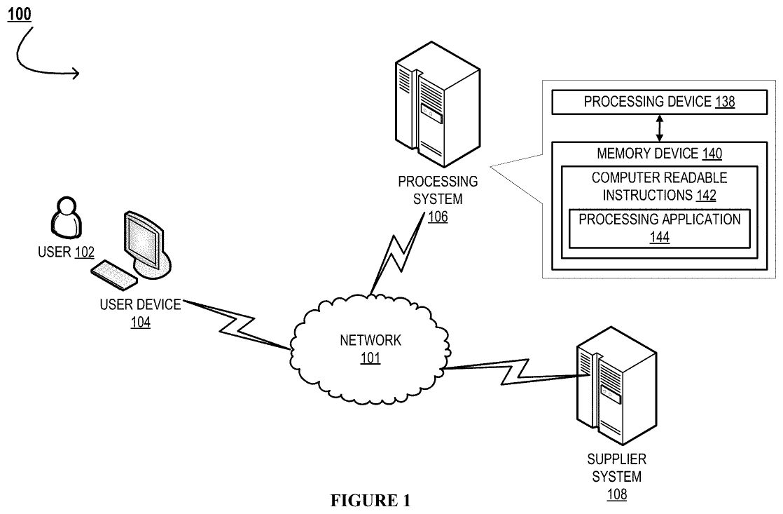

FIG. 1 illustrates a processing system environment 100, in accordance with one embodiment of the invention. As illustrated in FIG. 1, a processing system 106 is operatively coupled, via a network 101 to a user system/device 104 associated with a user 102 and a supplier system 108 associated with the supplier entity. The processing system 106 may also be referred to as a “computing system”, “computing device,” “server” or “system”. The processing system 106 typically comprises at least one processing device 138 that is structured to perform one or more of the steps/functions associated with transforming user files using a machine learning algorithm and a natural language processing to determine and categorize supplier entities described herein (e.g., steps of process flows 200 and 300 described below). Typically, the at least one processing device 138 is structured to perform one or more of the steps/functions described herein based on executing computer readable instructions/code 142 of a processing application 144 stored on a memory device 140. The processing system 106 may be in operative communication with and may transmit signals to and receive signals from, the user device 140 and/or the supplier system 108 associated with the supplier entity. FIG. 1 illustrates only one example of an embodiment of the system environment 100, and it will be appreciated that in other embodiments one or more of the systems, devices, or servers may be combined into a single system, device, or server, or be made up of multiple systems, devices, or servers. The network 101 may be a global area network (GAN), such as the Internet, a wide area network (WAN), a local area network (LAN), near field communication network, audio/radio communication network, ultra-high frequency wireless communication network, or any other type of network or combination of networks. The network 101 may provide for wireline, wireless, or a combination wireline and wireless communication between devices on the network 101.

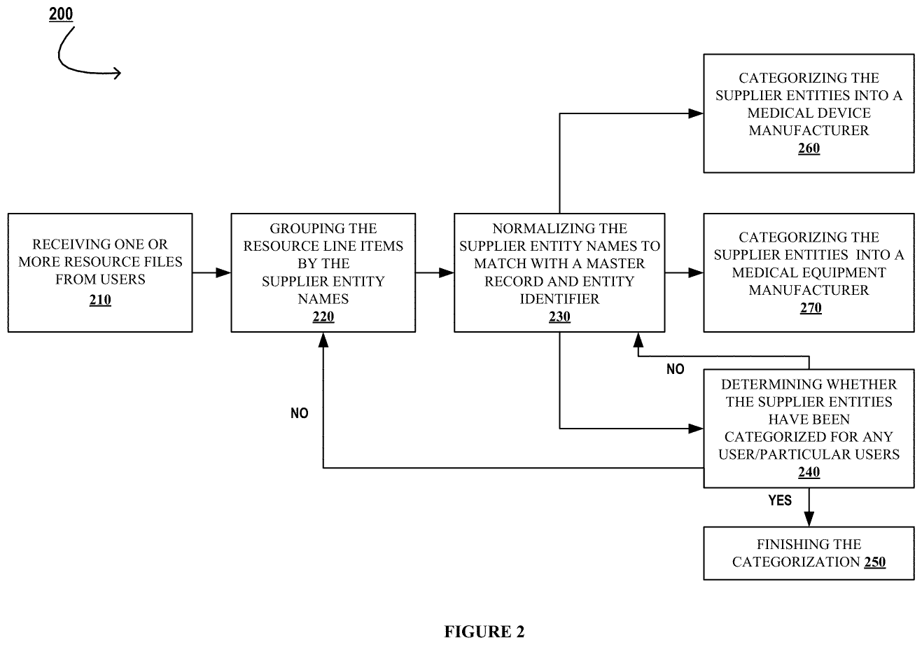

FIG. 2 illustrates a high level process flow 200 for a method and process for transforming user files using a machine learning algorithm and a natural language processing to determine and categorize supplier entities, in accordance with one embodiment of the invention. As indicated previously, in some instances, the high level process flow 200 relates to applying a machine learning algorithm and a natural language processing to user files to categorize supplier entities, such as suppliers, into category types, such as a category of service, based on the supplier entity identifiers, such as supplier names. Some or all of the steps of the process flow 200 may be performed by the system 106.

As illustrated by FIG. 2, the method of categorizing supplier entities (e.g., suppliers) into an identified category may commence with receiving one or more resource files from one or more users, as indicated by block 210. In this regard, the one or more resource files may be transmitted to the system 106 from user devices 104 associated with the one or more users/customers. In some instances, the one or more resource files are account payable files associated with the one or more users.

Next, as indicated by block 220, the method involves grouping resource line items by the supplier entity names. Here, the method may involve, parsing resource line items in the one or more resource files, extracting the resource line items, and then grouping the resource line items in accordance with the respective entity names associated with the resource line items. In the instances where the one or more resource files are account payable files, the resource line items are account payable line items in the account payable files. Here, the account payable line items in the account payable file may be grouped in accordance with their respective supplier's names (i.e., entity names). The grouping resource line items may be performed by the system. In some embodiments, the account payable line item is selected from a group comprising supplier's names, service types provided by the supplier, the amount of money owed to suppliers, due date, payment terms, balance due, and/or the like.

The method further involves normalizing or otherwise transforming the grouped supplier entity names to match with a master record and entity identifier information, as indicated by block 230. In the instances where the one or more resource files are account payable files and the entity names are supplier's names, the method involves normalizing (or otherwise transforming) the supplier's names to match with a master record and supplier's identifications (i.e., entity identifier information). This step may be performed by the system 106 as well.

Specifically, in some embodiments, the master record comprises a spelling of each of the supplier entities (e.g., suppliers), wherein the master record is determined by a gold standard of how the spellings of each of the supplier entities (e.g., suppliers) should be persisted. For example, the spelling of the supplier entities (e.g., suppliers) can be analyzed to determine whether it is recorded. Using a double metaphone algorithm, the spellings of the supplier entities (e.g., suppliers) can be compared with the current supplier master records, and the supplier name can be renamed to the master record once it is determined as non-similar with the current supplier master records. A standard percentage, over 90 percentages, may be used to determine whether the suppliers should be renamed to the master record.

In this way, the supplier entity's (e.g., supplier's) identifications comprise an integer based identifier that uniquely identifies each supplier entity (e.g., supplier).

Next, as indicated by block 240, the method involves determining whether the supplier entities have been previously/historically categorized in predetermined category(s). Here, the method may involve determining/checking/verifying if supplier entities such as suppliers should be categorized in an identified category for any customer/particular user or customer in the past.

Specifically, in some embodiments, the spelling of the supplier entities (e.g., suppliers) can be analyzed to determine whether it was categorized by the user (i.e., the user associated with the resource file such as the account payable file). If the supplier entity (e.g., supplier) has not been categorized for the user previously, the supplier entity's (e.g., supplier's) names are searched across a customer database to determine if the supplier entities (e.g., suppliers) have been categorized to generate a determined result. In response to the determined result, the method involves using a pre-categorized value to categorize the supplier entities (e.g., suppliers) into an alternative category.

It is noted that, the user/customer database consists of numerous names for the supplier entities (e.g., suppliers).

In response to determining that supplier entities have been previously/historically categorized in predetermined category(s), the method may involve finishing the categorization, as indicated by block 250. In other words, the method may complete/finish categorizing the suppliers in the identified category. These steps may be performed by the system 106 as well.

In accordance with some embodiments, the method further comprises categorizing supplier entities (e.g., suppliers) by or based on their medical device manufacturers, as indicated by block 260. This may be performed alone or in addition with the steps of block 240. It is noted that this categorization supports the user to understand that the supplier entities (e.g., suppliers) are the medical device manufacturers without requiring the users to know or analyze contracts. Accordingly, once the supplier entity (e.g., supplier) is categorized into a category of medical device manufacturer, the next individual/user can be determined as the medical device manufacturer, which can be provided to the user 102 (i.e., customer).

In accordance with some embodiments, the method further comprises categorizing supplier entities (e.g., suppliers) by or based on their medical equipment manufacturers, as indicated by block 270. This may be performed alone or in addition with the steps of blocks 240 and/or 260. Accordingly, once the supplier entity (e.g., supplier) is categorized into a category of the medical equipment manufacturer, the next individual/user can be determined as the medical equipment manufacturer which can be provided to the user 104 (i.e., customer).

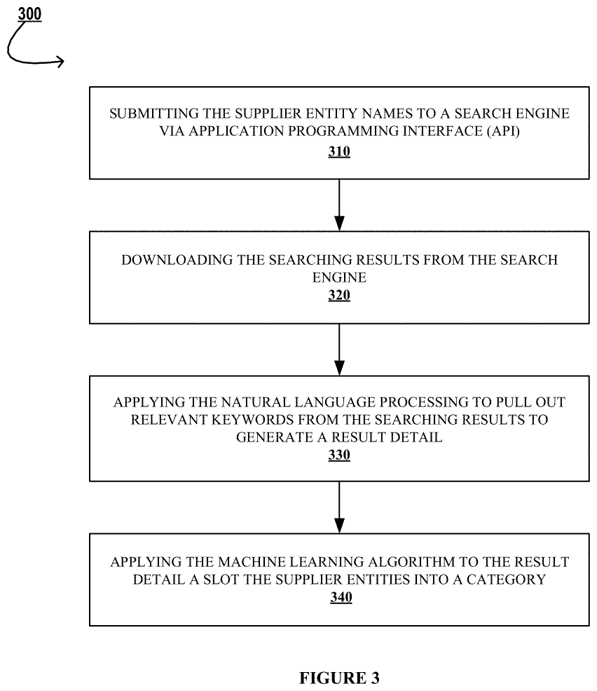

FIG. 3 illustrates a high level process flow 300 for a method and process for transforming user files using a machine learning algorithm and a natural language processing to determine and categorize supplier entities, in accordance with another embodiment of the invention. As illustrated by process flow 300, the spelling of the supplier entities (e.g., suppliers) can be analyzed to determine whether they have been categorized by the customer who provides the account payable file (e.g., as previously discusses with respect to block 240 of FIG. 2).

The steps of the process flow 300 may be performed by the system 106. If the supplier entity (e.g., supplier) has not been categorized for the user/customer 102, the supplier entities' (e.g., suppliers') names may be submitted to a search engine via an application programming interface (API) to generate a searching result, as indicated by block 310. In some embodiments, the application programming interface (API) may be a part of the system 106. In some embodiments, the searching results are in JSON format with all advertisings omitted and comprise texts as an abstract and URLs for the entire webpage. In addition, the JSON searching results are ranked in order of relevance from the most relevant to the least relevant. Accordingly, the application programming interface is configured to send requests to the search engine and receive responses therefrom. Accordingly, the search engine can connect with a plurality of supplier entities' (e.g., suppliers') databases through the application programming interface. As illustrated by block 320, the searching results can be downloaded.

Next, at block 330, the method may involve applying the natural language processing to pull out relevant keywords from the searching results to generate a result detail. Subsequently, at block 340, the method may involve applying the machine learning algorithm to the result detail a slot the supplier entities into a category. In other words, the relevant keywords can be pulled out from the searching results by a natural language processing and then can be categorized into an alternate category by a machine learning algorithm.

In some instances, the relevant keywords comprise any non-article piece of language, and the searching results comprise a result detail having an array of words which determined by bigram/trigram words fragments that the pre-trained natural language processing model has been determined to be relevant. In yet another embodiment, the stop words, such as “the” and “a” have been removed in the bigram/trigram words fragments

In some embodiments, the present invention uses a combination of multinomial naive Bayes, logistic regression, random forest classification, and support vector machines to generate a confidence score. The confidence score is generated for a set of categories that the supplier is likely to match with the searching results. Subsequently, the searching results can be ranked with the highest confidence score and is automatically saved in a customer database once the highest confidence exceeds a threshold of 0.90. If no category has a higher enough confidence score, the supplier is set aside for manual categorization, which can then be used to improve the current model of the present invention.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s). The computer program product comprises a non-transitory computer-readable storage medium having computer-executable instructions.

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of a method for using a machine learning algorithm and a natural language processing to categorize service suppliers have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C . . . and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims, therefore, include not only the combination of elements which are literally set forth but all equivalent structure, material or acts for performing substantially the same function in substantially the same way to obtain substantially the same result. In this sense, it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub combination or variation of a sub combination.

What is claimed is:

1. A method of categorizing supplier entities into an identified category, comprising:
receiving a resource file from a user;
grouping resource line items in the resource file based on supplier entity names;
normalizing the supplier entity names to match with a master record and supplier entity identifications;
determining if the supplier entities should be categorized in the identified category for any user/particular user in the past, and
categorizing the supplier entities in the identified category.

2. The method of claim 1, further comprising categorizing the supplier entities by a medical device manufacturer.

3. The method of claim 1, further comprising categorizing the supplier entities by a medical equipment manufacturer.

4. The method of claim 1, wherein the resource line item is selected from a group consisted of supplier's names, service types provided by the supplier, the amount of money owed to supplier, due date, payment terms, and balance due.

5. The method of claim 1, wherein the master record comprises a spelling of each of the supplier entity names.

6. The method of claim 1, wherein each of the supplier entity's identifications comprises an integer based identifier that uniquely identifies each supplier entity.

7. The method of claim 1, wherein if it is determined that the supplier entity should not be categorized in the identified category, the method further comprises:
searching the supplier entity's names across a user database to determine if the supplier entities have been categorized to generate a determined result; and
in response to the determined result, using a pre-categorized value to category the supplier entities into an alternative category.

8. The method of claim 1, wherein if it is determined that the supplier entities should not be categorized in the identified category, the method further comprises:
submitting the supplier entity's names to a search engine via an application programming interface to generate a searching result;
downloading the searching result;
applying a natural language processing to pull out relevant keywords from the searching results; and
applying a machine learning algorithm to categorize the supplier entities into an alternate category.

9. The method of claim 8, wherein the application programming interface is configured to send requests to the search engine and receive responses therefrom.

10. The method of claim 8, wherein the search engine can connect with a plurality of supplier entity's database through the application programming interface.

11. The method of claim 8, wherein the searching results are in JSON format with all advertisings omitted.

12. The method of claim 8, the relevant keyword is a combination of bigram and trigram word fragments.
